(19) United States
(12) Patent Application Publication
(10) Pub. No.: US 2012/0324396 A1
(43) Pub. Date: Dec. 20, 2012

(54) METHOD FOR QUICK APPLICATION ATTRIBUTE TRANSFER BY USER INTERFACE INSTANCE PROXIMITY

(75) Inventors: Randall P. Baartman, Pine Island, MN (US); James E. Carey, Rochester, MN (US); Jenny S. Li, Danbury, CT (US); John S. Mysak, Rochester, MN (US)

(73) Assignee: International Business Machines Corporation, Armonk, NY (US)

(21) Appl. No.: 13/162,613

(22) Filed: Jun. 17, 2011

(51) Int. Cl. G06F 3/048

(52) U.S. Cl. 715/788

(57) ABSTRACT

Techniques are described for allowing a user to designate one of the windows on a display device (e.g., computer monitor) as a model window. Doing so permits the user to transfer the settings of an attribute (e.g., a font, color scheme, security setting, display of a toolbar, a user-defined attribute etc.) associated with the model window to another window located on the display device once the user moves the model window within a certain distance of the other window. The settings of the attributes of the model window are then transferred to the attributes of the other window. Moreover, the assigned settings may be rolled back after a specified amount of time has elapsed. The window whose attributes were changed may then revert back to either default settings or the settings before the attributes were changed to the attribute settings of the model window.

### BACKGROUND

1. Field of the Invention

Embodiments of the present invention generally relate to assigning attributes between two windows in a graphical interface. Specifically, the invention relates to detecting a predetermined proximity between two windows and transferring attribute settings of one window to the other.

2. Description of the Related Art

Typical user interface systems allow sets of similar windows to coexist simultaneously. For example, a desktop session displayed on a monitor may have multiple windows that each represent an instance of the same application. That is, a desktop session may have multiple windows of the same application open at one time. In general, an application is any program that runs on a computer system, for example, a text editor, instant-chat messenger, internet browsers, and the like. The computer system could be a personal computer, server, tablet, cell phone, etc.

Each window typically has multiple attributes associated with the application—e.g., font, color, text size, toolbars, etc. Many applications permit the user to customize the settings of the attributes. However, there is no easy way of changing the attribute settings when there are multiple windows of the same application running during a desktop session. To change the attribute settings for all the windows, a user must either change the attributes for each window individually or close the active windows, reconfigure the default settings for the application, and restart the windows.

Currently, there is no convenient method of transferring the settings of an attribute of one window to another window.

### SUMMARY

Embodiments of the invention provide a method, system and computer program product that transfer an attribute setting from a first window to a second window. The method, system and computer program output a first window and a second window for display on a display device where the first and second windows each have a defined boundary on the display device and an attribute with a default setting. Moreover, the attribute is user-customizable. The method, system and computer program set the first window as a model window and, upon determining that at least one reference point of the model window is located within a predetermined distance from a reference point of the second window on the display device, assign a setting of the user customizable attribute of the model window to the user customizable attribute of the second window.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for transferring attributes between windows, according to one embodiment of the invention.

FIG. 2 is a flow chart illustrating a process for transferring attributes between windows, according to one embodiment of the invention.

FIG. 3 is a figure illustrating two windows, according to one embodiment of the invention.

FIG. 4 is a graphical display for modifying model settings, according to one embodiment of the invention.

FIG. 5 is a figure illustrating two windows transferring attributes, according to one embodiment of the invention.

FIG. 6 is a figure illustrating two windows transferring attributes, according to one embodiment of the invention.

FIG. 7 is a figure illustrating a window reverting to default settings, according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

A display device may permit a user to open multiple windows at one time. Further, at least two windows may be separate instances of the same application. For example, a user may have two documents of the same word processing application open in separate windows. Each window has certain attributes that are customizable by the user, such as the type of font, the color of the text, or which toolbars to display. With many applications, however, changing the attributes of one window or instance of that application does not change the attributes of another active window of that same application.

In embodiments of the present invention, a user designates one of the windows as a model window. This designation permits the user to grab a window using an I/O device and move it near or overlapping with other windows. Once the model window comes within a certain distance of a window of the same application, the attribute settings of the model window are assigned to the attributes of the other window. For example, if the font (i.e., an attribute) of the model window was set to Times New Roman (i.e., a setting of the attribute), the font of the other window is also set to Times New Roman.

In one embodiment, the assigned settings may revert after a timer expires if, for example, the user wants the assignment to be temporary. The window whose attributes were changed may then revert back to either the default settings or the settings before the attributes were changed by moving the window within a predetermined distance of the model window. In another embodiment, the computer system may alert the user when settings are changed.

In one embodiment, attribute settings of the model window are transferred to another window on the display device even if the windows are not separate instance of the same window. After determining which attributes the windows have in common, only the settings for those common attributes are transferred from the model window to the other window. For example, if the model window is instance of a text editor and the other window is an instance of an instant messenger, then the settings for the attributes the two applications have in common, such as font type and size, may be transferred when the two windows come within a certain distance of each other on the display device.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

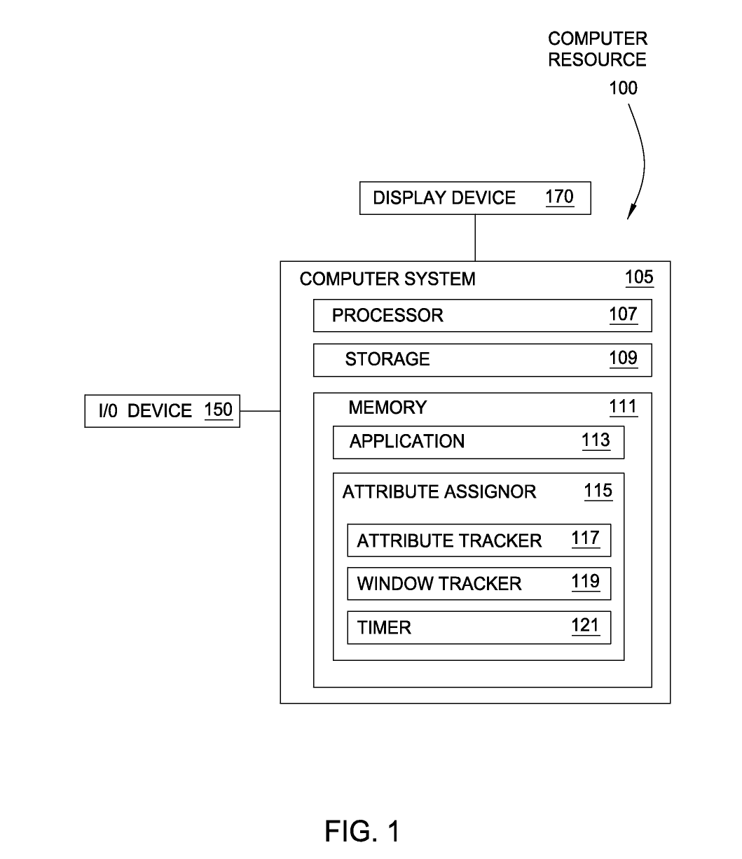

FIG. 1 is a block diagram illustrating a system for transferring attributes between windows, according to one embodiment of the invention. Computer resource 100 includes a display device 170, an I/O device 150, and a computer system 105. The display device 170 displays at least one window whose boundary may consist of all or only a portion of the viewable area (i.e., screen) of the display device 170. The display device 170 may be a stand-alone monitor, such as an LCD or CRT monitor display, or a built-in display for a laptop computer, portable MP3 player, cell phone, tablet computer, or any other known or future device that may benefit from the process described herein. Though the display device 170 is shown separate from the computer system 105, in one embodiment the display device 170 may be integrated into the computer system 105.

The I/O device 150 is any device that enables the user to interact with the computer system 105. Example I/O devices 150 include mice, keyboards, motion sensors, eye-trackers, or scroll-balls. Like the display device 170, the I/O device 150 may be integrated within the computer system 105 (e.g., a scroll-ball on a cell phone). Moreover, the I/O device 150 and the display device 170 may be integrated together such as in a touch screen for a cell phone, MP3 player, or tablet computer. Conversely, the I/O device 150 and the display device 170 may not be directly connected to the computer system 105 but may use a network (e.g., a LAN or WAN) to communicate with the computer system 105. A person of ordinary skill in the art will recognize the different ways of combining the display device 170, the I/O device 150, and the computer system 105.

The computer system 105 includes a processor 107, a storage device 109, and memory 111. The processor 107 may be any processor adapted to support the methods of the invention. Storage 109 includes hard-disk drives, flash memory devices, optical media and the like. The memory 111 is any memory sufficiently large to hold the necessary programs and data structures. Memory 111 could be one or a combination of memory devices, including Random Access Memory, nonvolatile memory, or backup memory (e.g., programmable or Flash memories, read-only memories, etc.). In addition, memory 111 and storage 109 may be considered to include memory physically located elsewhere from the computer resource 100, for example, on another computer coupled to the computer system 105 via a network.

The memory 111 includes an application 113 and an attribute assignor 115. The application 113 is any software or hardware application 113 that may have more than one instance of the application 113 represented by a window in a display device 170. Even though a window is a graphical representation of an instance, the “instance” of an application and the “window” of an application may be considered synonymous terms and are used interchangeably. Applications 113 include word processors, instant-messaging systems, internet browsers, and the like.

The attribute assignor 115 includes attribute tracker 117, window tracker 119, and timer 121. The attribute tracker 117 maintains a record of the attributes and their accompanying setting for each window of an application 113. The window tracker 119 records the location of windows currently being displayed on the display device 170 and determines distances between the boundaries of the respective windows. The timer 121 records the amount of time that has elapsed since the attributes of one window have been assigned to another or the time that has elapse since a window was designated as the model window. The timer 121 alerts the attribute assignor 115 when assigned attribute settings should be reverted back to the prior settings.

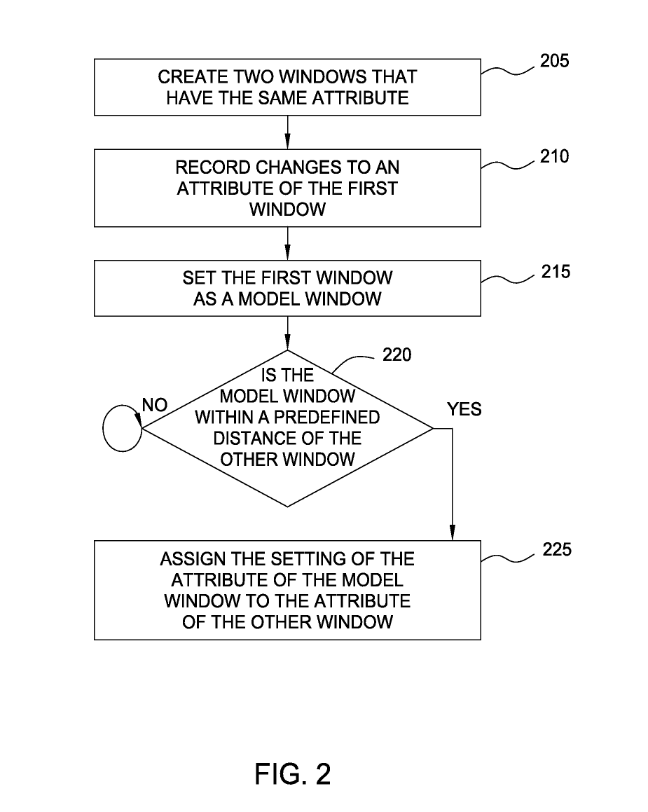

FIG. 2 is a flow chart illustrating a process for transferring attributes between windows, according to one embodiment of the invention. At step 205, the computer system 105 creates two windows of the same application 113. This may occur when prompted by the user (e.g., the user creates two new document windows for a text editor), the computer system 105 itself, a separate application 113, or by a remotely connected computer system. In the remainder of this document, it may be assumed that the windows displayed of the display device 170 are instances of the same application unless stated otherwise.

At step 210 the attribute tracker 117 records the attributes of the windows. The attribute tracker 117 may record any changes to attributes regardless of whether the windows are currently displayed in the display device 170. That is, a user or application 113 may change the setting of an attribute when the window is not displayed.

With many applications 113, when a window is first opened or created the attributes are assigned default settings. For example, all windows of an instant-messaging system may default to a type size of 14 when the windows are created. Moreover, a default setting for an attribute may set the attribute as inactive. For example, the default setting may be to disable a plug-in when a window starts or not to display a toolbar in the window. The user may then customize the attribute setting using an I/O device 150. In general, an attribute is any feature of an application that is customizable by a user. Once the user changes the setting of the attribute, the attribute tracker 117 records this change. In one embodiment, each application 113—instead of the attribute tracker 117—may track and record the attributes for each currently active window of that application 113.

Attributes may be categorized into multiple types. One type of attribute may be attributes affecting the cosmetic appeal of the window. Example of this type include font style, font size, font color, size of the window, color scheme of the window or other similar features. A second type of attribute may be attributes that affect the displayed structure of the window. This type may include rearranging portions of the window and adding or deleting toolbars. A third type includes functional settings of a window. This type consists of security settings, networking settings, or shortcuts/hotkeys. These attributes may run in the background (i.e., are not displayed) but still have unique settings for each window or instance of the application 113. For example, internet browsers allow a user to either accept or reject cookies from visited sites. In some browsers (i.e., applications 113) a user must either change the security setting for each window or change the default setting and then restart all of the windows. The present invention streamlines this lengthy process.

At step 215, the user sets a window as the model window. In general, the model window has the attribute settings that the user desires to transfer or assign to other windows of the same application 113. Although the present embodiments assume that the multiple windows are instances of the same application 113, the windows may be instances of separate applications 113 so long as at least one of the windows' attributes are the same. For example, a first window may be an instance of an instant-messaging system while a second window is an instance of a text editor. If both the first and second windows have an attribute that permits the user to customize the font, then the setting for the font for the first window may be transferred to the second window using the method disclosed herein. The attribute assignor 115 may determine the attributes shared between the two windows and only transfer the settings for the attributes that are the same.

In one embodiment, the attribute may be defined by the user. For example, a user having a chat conversation with a first person may define the chat history (i.e., context) as an attribute. Once the attribute is defined, the attribute assignor 115 may move the chat history (i.e., the attribute) to a second chat window of the chat application once the windows are within the predefined distance. In this manner, a second person associated with the second chat window may see the conversation that the user had with the first person. In addition to viewing the original conversation, transferring the attribute may allow the second person to be included in all future correspondence between the user and the first person. An application 113 may display a graphical user interface that permits a user to select what information is labeled as an attribute. A user-defined attribute provides freedom to the user to identify an attribute beyond the attributes established by the application 113.

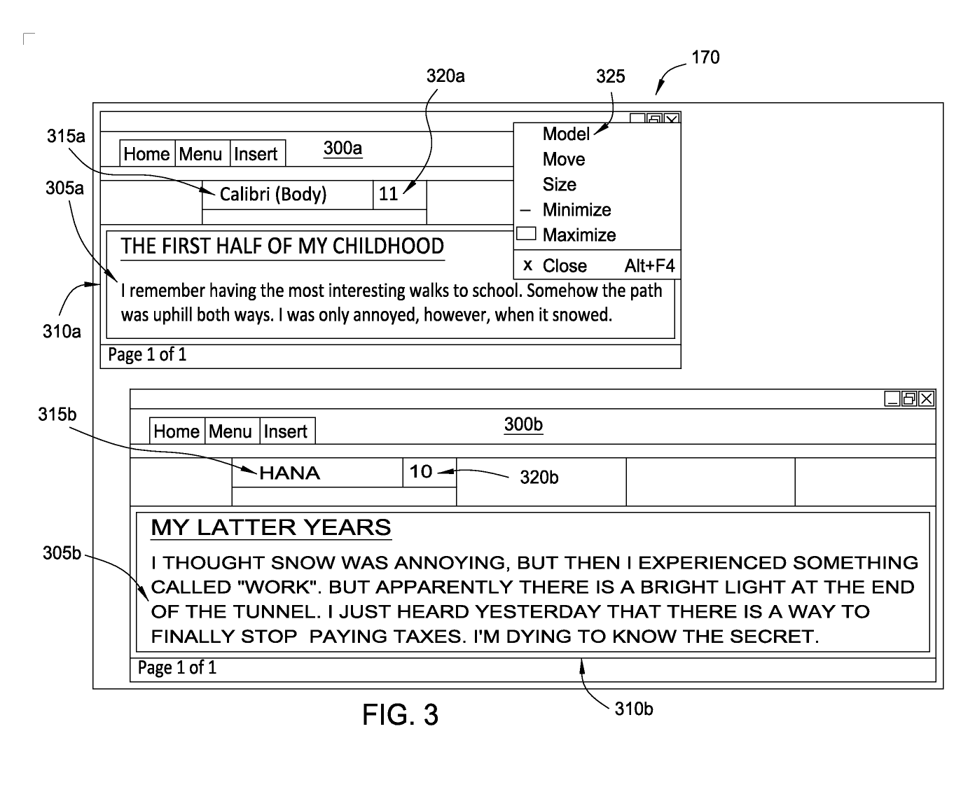

FIG. 3 illustrates two windows in a screen of a display device, according to one embodiment of the invention. Specifically, FIG. 3 shows an image or a screen capture of a display device 170 with two windows 300. The first window 300a has a body 305a that is defined by the boundary 310a. The boundary 310a specifies the graphical location of the window within the display device 170. The boundary 310a is not limited to any particular shape but may be a polygon with any number of sides, a circle or ellipse, or even 3-D. A user or other program may then move the window by any means well known in the art. Moreover, the shape and size of the boundary 310a and body 305a may be increased, shrunk, or altered. For example, a user may use the I/O device 150 to grab and move the window to a different graphical position within the display device 170. The distance between the two windows 300 may be measured regardless of whether the user moves the first or the second window 300. The second window 300b also has a body 305b and boundary 310b that has the same characteristics as the body 305a and boundary 305a for first window 300a. The window tracker 119 of the attribute assignor 115 records and maintains the current graphical locations of the windows 300 in the display device 170. By recording the location of the boundaries 310 for each window 300, the window tracker 119 can then measure a distance between the windows 300.

In one embodiment, the distance between the first and second windows 300 is the defined by a distance between two points of reference each on the respective windows 300. For example, the window tracker 119 may place a reference point at the center of the bodies 305 for each of the windows 300. As a user or application moves the center of the windows 300 closer together, the windows tracker 119 measures the distance between the reference points and determines if they are within a predetermined distance.

In one embodiment, the distance between the first and second windows 300 is the length of a line that is defined by a reference point on the boundary 310a of the first window 300a that is closest to the second window 300b and a reference point on the boundary 310b of the second window 300b that is closest to the first window 300a. In this manner, the window tracker 119 records the current distance between each window 300.

The windows 300 also include a font type attribute 315 and a font size attribute 320. For the first window 300a, the setting of the font type attribute 315a is Calibri while the font size attribute 320a is 11. For the second window 300b, the setting of the font type attribute 315b is HANA and the font size attribute 320b is 10. The settings for the attributes 315b, 320b for the second window 300b may be, for example, the default settings for the application 113. The user may desire that the settings of the attributes 315b, 320b for the second window 300b match the settings of the attributes 315a, 320a for the first window 300a. The user then sets the first window as the model window using the model designator 325. The model designator 325 may be a activated by selecting an option in a drop-down menu or a toolbar, hitting a hotkey, moving the window to a particular location on the display device 170, a sequence of mouse clicks and the like. In FIG. 3, the model designator 325 is found in a menu that the user can access with a mouse cursor. Once selected or activated, the first window 300a is the model window. The first window 300a may also be deselected as the model window, for example, when the user has finished transferring the desired settings of the attributes 315, 320. The first window 300a may be deselected in the same manner that it is selected as the model window.

In one embodiment, the attribute assignor 115 may automatically choose the model window without the user selecting the window. For example, the attribute tracker 117 may detect when a user changes an attribute from a default setting and automatically set the associated window as the model window. The user would then be able to change the model status of the window if she did not want to attribute setting to be shared with other windows.

Although the windows 300 are shown as being instances of the same application, because the windows 300 share similar attributes (i.e., font type and size), the windows 300 may be instances of two separate applications and still perform the method described herein.

In one embodiment, the window 300a selected as the model window may have a model status 505 that informs the user that the window has been selected as the model window. For example, the model status 505 may appear on the display device 170 to alert the user that the window may now be used to assign attributes to other windows. The model status 505 is not limited to appearing within the boundary 310a of the model window. Instead, the model status 505 may appear in a corner of the display device 170 when the model window is “in focus”. The model window is “in focus” if, when multiple windows 300 occupy the same portion of the display device 170, the model window is displayed on the top of the stack. In another embodiment, the model status 505 may be an audio alert rather than a graphical display.

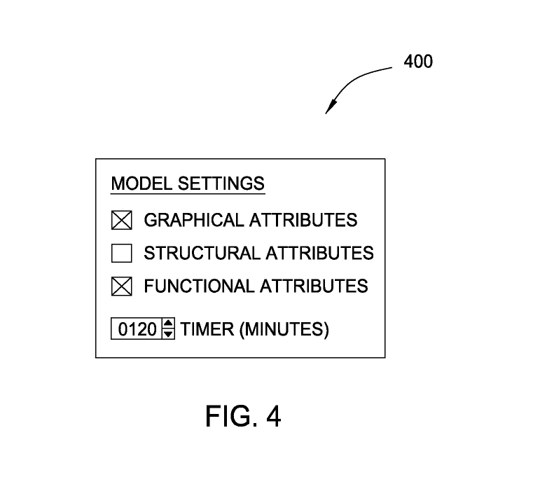

FIG. 4 is a graphical display for modifying model settings, according to one embodiment of the invention. In addition to permitting the user to designate a model window, the attribute assignor 115 may have an associated user interface (UI) 400 as shown in FIG. 4. The UI 400 allows the user to adjust the type of attributes that are monitored by the attribute tracker 117. Examples of types of attributes may be the three types discussed in detail above: graphical, structural, or functional attributes. As shown, the checkboxes next to an attribute instruct the attribute tracker 117 to record the settings of those attributes in the model window and transfer the settings to a target window once the window tracker 119 determines the target window is within a certain distance from the model window. In FIG. 4, the attribute tracker 117 records the settings for the graphical and functional attributes of the model window but ignores the settings for the structural attributes. In one embodiment, selecting an attribute type in the UI 400 may further display a drop-down menu (not shown) that allows a more granular selection of specific attributes categorized within that attribute type.

The UI 400 may also include a tool for setting the timer 121 associated with the attribute assignor 115. As will be discussed in greater detail below, the timer 121 instructs the attribute assignor 115 when to revert or rollback changes made to the settings of a target window.

Returning to FIG. 2, at step 220 the window tracker 119 determines when the model window is within a predetermined distance of another window that is either an instance of the same application as the model window or has at least one attribute in common with the model window. As mentioned above, the window tracker 119 maintains the distance between the boundaries 310 of windows 300. Further, the window tracker 119 compares the distance between the two windows 300 to a predetermined distance to ascertain whether the two windows 300 are within the predetermined distance. The predetermined distance controls the sensitivity of the attribute assignor 115. That is, the greater the predetermined distance, the more likely that the window tracker 119 will detect a collision between the model window and a target window—i.e., the two windows are separated by a distance less than the predetermined distance. In one embodiment, the predetermined distance may be zero. In such a case, the window tracker 119 detects a collision when the boundaries 310 of the windows 300 touch, or when the bodies 305 of each window 300 overlap.

A user may move a window by any means known by a person of ordinary skill in the art, for example, by using an I/O device 150 such as a mouse. Moreover, the user may manipulate a position of a window 300 when the I/O device 150 and display device 170 are integrated in a touch screen. In one embodiment, a window 300 is moved simply by resizing the boundary 310. As long as some portion of the body 305 or boundary 310 of the window 300 is located in a different area of the display device 170, then the window tracker 119 may recalculate the distance between the windows 300 to ascertain whether the windows 300 are within the predetermined distance. If the user has yet to designate a model window, then moving the windows 300 within a predetermined distance does not transfer the attribute settings.

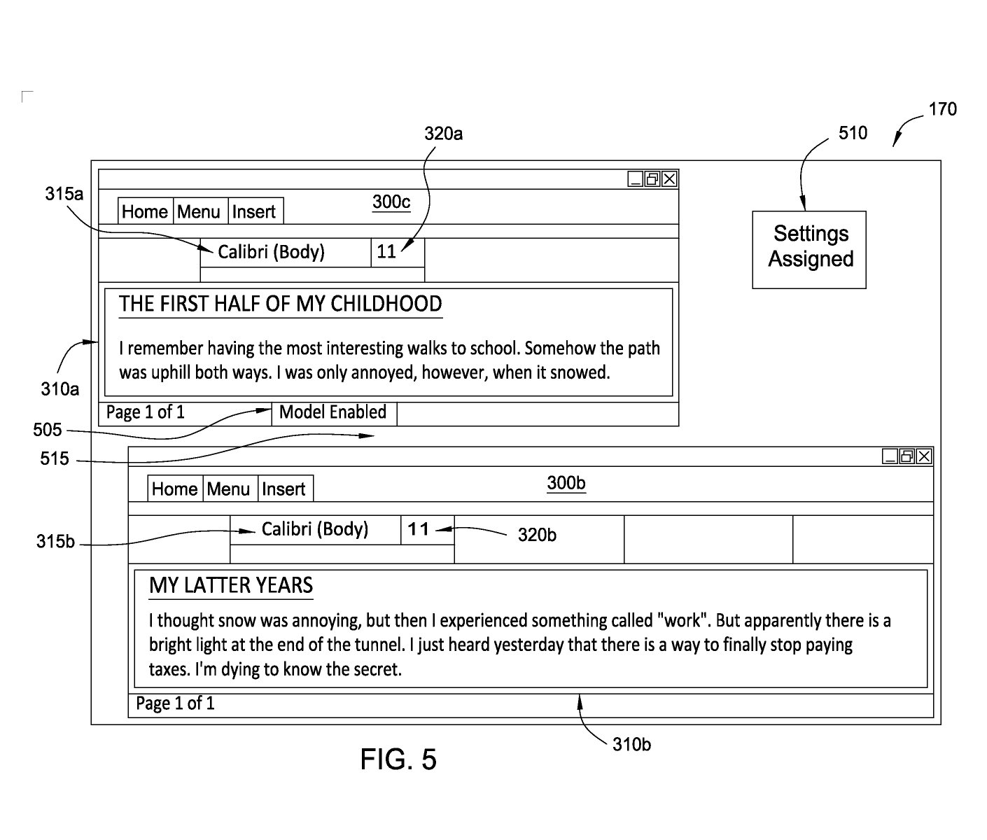

FIG. 5 is a graphical display for modifying attribute settings when two windows are within a predetermined distance, according to one embodiment of the invention. FIG. 5 has both a model window 300c and the second window 300b. The user has moved either the model or second window 300 such that the two windows 300 are within a predetermined distance 515 of each other. Stated differently, the windows 300 may be within the predetermined distance 515 of each other regardless of whether the user moved the model window 300c or the second window 300b. In one embodiment, a line drawn between the closest points of the boundaries 310 to each window establishes the distance between the windows 300. Once the line becomes shorter than the predetermined distance, the window tracker 119 alerts the attribute assignor 115.

In FIG. 2, once the attribute assignor 115 receives the alert, at step 225 the attribute assignor 115 assigns or transfers the attribute settings of the model window 300c stored by the attribute tracker 117 to the attributes of the second window 300b. As shown in FIG. 5, the font type attribute 315b of the second window 300b now matches the font type attribute 315a of the model window 300c. Similarly, the font size attribute 320b also matches the font size attribute 320a of the model window 300c. The type of attribute determines whether the changed setting will be displayed on the display device 170 for the user to see. For example, if the attribute in the model window 300c is a security setting, there may not be a graphical display of that setting. Nonetheless, once the model window 300c is within a predetermined distance to the second window 300b, the setting of the attribute may be transferred to the second window 300b.

In one embodiment, the attribute assignor 115 may not automatically transfer the attribute settings of the model window 300c to the second window 300b once the two windows 300 are within the predetermined distance. Instead, the attribute assignor 115 may cause a UI (not shown) to be displayed on the display device 170. Using the UI, the user may select which attribute settings to assign to the second window 300b. In this manner, the UI presents all of the attributes in a concise list which the user may use to quickly choose the settings to assign. The UI also may be used to ensure the user wants to transfer the attribute. For example, the user may have mistakenly moved the windows 300 within the predefined distance and does not want the attributes to transfer. The UI may include accept/reject buttons that enable the user to stop the transfer.

In one embodiment, the attribute assignor 115 may provide an alert 510 to indicate when the assignment of settings between a model window 300c and a second window 300b has occurred. The alert 510 may be especially helpful when the attribute assignor 115 transfers settings that do not have a graphical effect on the second window 300b, e.g., security settings or assignments for hotkeys. The alert 510 may be either graphical or audio and continue for a specified amount of time.

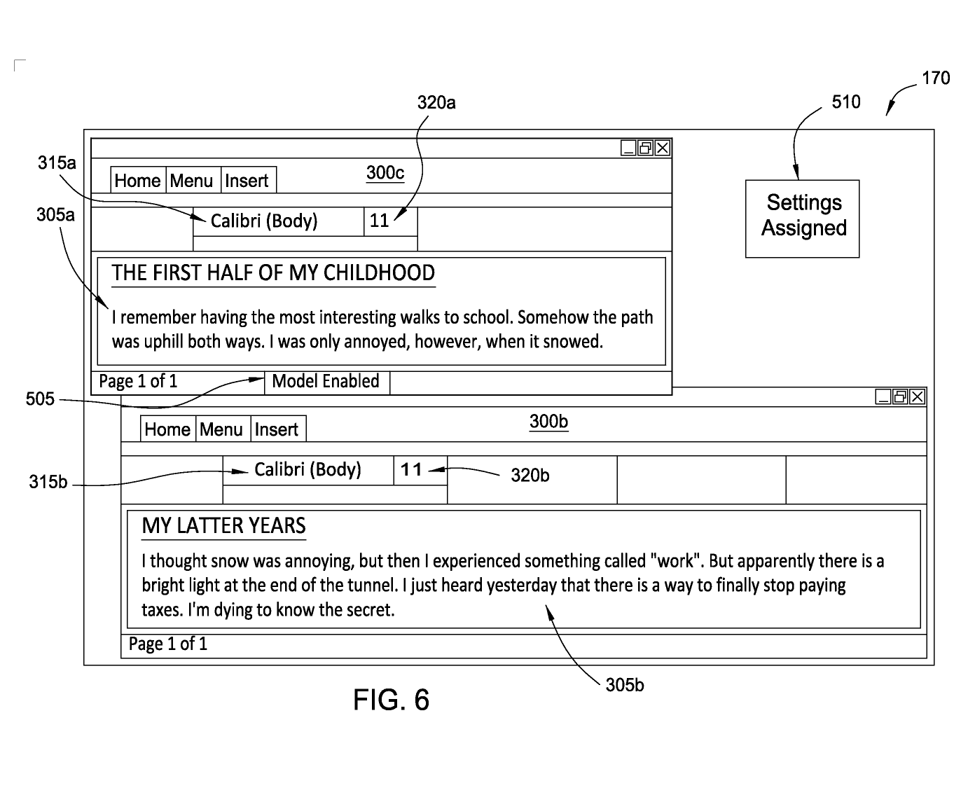

FIG. 6 is a figure illustrating two windows transferring attributes, according to one embodiment of the invention. The windows 300 in FIG. 6 are overlapped. In this embodiment, the window tracker 115 detects a collision when the predetermined distance between a model window 300c and a second window 300b is zero—i.e., the bodies 305 of the windows 300 touch or overlap. Setting the predetermined distance to zero decreases the sensitivity of the attribute assignor 115. Accordingly, the user has greater control of the model window 300c to prevent an accidental transfer of attributes to other windows. However, once the windows 300 overlap, the result is the same as that of FIG. 5. That is, the font type attribute 315a and font size attribute 320a of the model window 300c now match the font type attribute 315b and font size attribute 320b of the second window 300b.

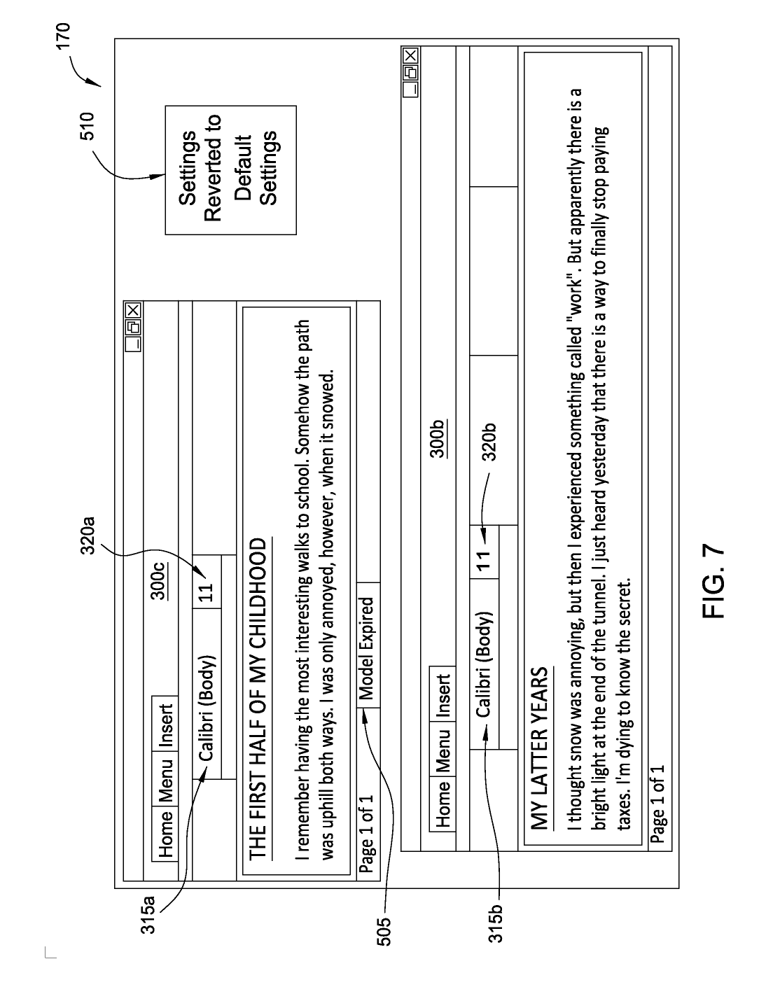

FIG. 7 is a figure illustrating a window reverting to default settings, according to one embodiment of the invention. As mentioned previously, the assignment of the attributes from the model window 300c to the second window 300b may be temporary. In one embodiment, the attribute assignor 115 uses the timer 121 associated with the assignment to determine when the assignment expires.

In one embodiment, before the attribute assignor 115 transfers the settings of the model window 300c to the second window 300b, the attribute tracker 117 saves the current settings of the attributes of the second window 300b. In this manner, the attribute settings of the second window 300b are preserved. Once the timer expires, the attribute assignor 115 uses the saved settings to roll back the attribute settings of the second window 300b.

As shown in FIG. 7, the attribute assignor 115 rolled back the font type attribute 315b and the font size attribute 320b to the font type and size settings that existed before the attribute assignor 115 transferred the attribute settings of the model window 300c to the second window 300b. This reversion occurs when a timer 121 associated with the transfer expires. For example, each transfer of attribute settings from the model window 300c to a target window may have an associated timer 121 that either counts up to, or counts down from, a predetermined time. As each timer 121 expires, the associated target windows revert back to their prior settings. Alternatively, a single timer 121 may be associated with a model window 300c, and when the timer 121 expires, the attribute assignor 115 rolls back the settings for every target window changed by the settings of the model window 300c. In this case, the model status 505 may indicate that model status has expired. After the timer 121 terminates, the attribute assignor 115 no longer assigns the settings of the attributes 315a, 320a to the second window 300b when the two windows 300 are within a predetermined distance of each other. If the user desires to transfer attribute settings from the model window 300c to a target window, she may again enable the model feature of the window. In one embodiment, the user may manually terminate the status of the model window 300c. In this manner, the model status 505 may say “Model Disabled” to alert the user that the attribute assignor 115 will no longer transfer the attribute settings of the model window 300c.

In one embodiment, when the timer 121 expires, the attribute assignor 115 may roll back the settings of the second window 300b to the default settings that were assigned to the second window 300b by the application 113. This embodiment ignores any changes made to the attribute settings of the second window 300b before the attribute assignor 115 assigned the attribute settings of the model window 300c to the second window 300b. Stated differently, after the timer 121 expires, the attribute assignor 115 assigns the settings of attributes 315b, 320b to the same settings that were assigned to the window 300b when the window 300b was created. If the default settings assigned by the application 113 changed before the timer 121 expires, the attribute assignor 115 may roll back the attribute settings of the second window 300b to the new default settings.

In one embodiment, the user may save the second window 300b before the timer 121 expires. Doing so prevents the settings of the attributes 315b, 320b from reverting once the timer 121 expires. A window may be saved accordingly to any method known to a person skilled in the art.

In one embodiment, the display device 170 may show a graphical alert 510 to indicate that the attribute settings of the second window 300b have reverted—e.g., when the timer 121 expires. This graphical alert 510 may flash or move around the screen of the display device 170 to attract the user's attention. The computer resource 100 may also use an audio alert 510 such as a beep.

By maintaining a record of the location and attribute settings of the windows 300 in a display device 170, a user may select a model window and pass the attribute settings of that window to other windows in the display device 170. Doing so permits the user to pass on the settings of attribute shared by the windows without having to manually customize those settings in each of the windows.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
outputting, by operation of one or more computer processors, a first window and a second window for display on a device, the first and second windows each having an attribute with a default setting, wherein the attribute is user-customizable and wherein the first and second windows each have a defined boundary on the display device;
setting the first window as a model window; and
upon determining that at least one reference point of the model window is located within a predetermined distance from a reference point of the second window on the display device, assigning a setting of the user customizable attribute of the model window to the user customizable attribute of the second window.

2. The method of claim 1, further comprising, after assigning the changed setting of the user customizable attribute of the model window to the user customizable attribute of the second window, setting a predetermined time for maintaining the assignment.

3. The method of claim 2, further comprising, reverting the user customizable attribute of the second window to the default setting when the predetermined time expires.

4. The method of claim 1, further comprising, before assigning the changed setting of the user customizable attribute of the model window to the user customizable attribute of the second window, storing a current setting of the user customizable attribute of the second window.

5. The method of claim 4, further comprising, after assigning the changed setting of the user customizable attribute of the model window to the user customizable attribute of the second window:
setting a predetermined time for maintaining the assignment; and
reverting the user customizable attribute of the second window to the stored current setting when the predetermined time expires.

6. The method of claim 1, wherein the first and second windows are instances of a same application and further comprising:
a third window that is an instance of a different application, the third window having a same user customizable attribute as the model window;
displaying the third window on the display device, wherein the third window has a defined boundary on the display device; and
upon determining that the boundary of the model window is located within a predetermined distance from the boundary of the third window on the display device, assigning the setting of the user customizable attribute of the model window to the same user customizable attribute of the third window.

7. The method of claim 1, wherein the boundary of the model window is located within a predefined distance from the boundary of the second window on the display device if at least one of (i) the first window overlaps the second window on the display device and (ii) the second window overlaps the first window on the display device.

8. The method of claim 1, wherein setting the first window as a model window is done upon receiving a prompt by a user.

9. The method of claim 1, wherein the at least one reference point of the model window is a point on the boundary of the model window.

10. A computer program product, the computer program product comprising:
a computer-readable storage medium having computer-readable program code embodied therewith, the computer-readable program code configure to:
output a first window and a second window for display on a device, the first and second windows each having an attribute with a default setting, wherein the attribute is user-customizable and wherein the first and second windows each have a defined boundary on the display device;
set the first window as a model window; and
upon determining that at least one reference point of the model window is located within a predetermined distance from a reference point of the second window on the display device, assign a setting of the user customizable attribute of the model window to the user customizable attribute of the second window.

11. The computer program product of claim 10, further comprising, after assigning the changed setting of the user customizable attribute of the model window to the user customizable attribute of the second window, setting a predetermined time for maintaining the assignment.

12. The computer program product of claim 11, further comprising, reverting the user customizable attribute of the second window to the default setting when the predetermined time expires.

13. The computer program product of claim 10, further comprising, before assigning the changed setting of the user customizable attribute of the model window to the user customizable attribute of the second window, storing a current setting of the user customizable attribute of the second window.

14. The computer program product of claim 13, further comprising, after assigning the changed setting of the user customizable attribute of the model window to the user customizable attribute of the second window:
setting a predetermined time for maintaining the assignment; and
reverting the user customizable attribute of the second window to the stored current setting when the predetermined time expires.

15. The computer program product of claim 10, wherein the first and second windows are instances of a same application and further comprising:
a third window that is an instance of a different application, the third window having a same user customizable attribute as the model window;
displaying the third window on the display device, wherein the third window has a defined boundary on the display device; and
upon determining that the boundary of the model window is located within a predetermined distance from the boundary of the third window on the display device, assigning the setting of the user customizable attribute of the model window to the same user customizable attribute of the third window.

16. A system, comprising:
a computer processor; and
a memory containing a program that, when executed on the computer processor, transfer an attribute setting from a first window to a second window, comprising:
outputting, by operation of one or more computer processors, the first window and the second window for display on a device, the first and second windows each having an attribute with a default setting, wherein the attribute is user-customizable and wherein the first and second windows each have a defined boundary on the display device;
setting the first window as a model window; and
upon determining that at least one reference point of the model window is located within a predetermined distance from a reference point of the second window on the display device, assigning the attribute setting of the user customizable attribute of the model window to the user customizable attribute of the second window.

17. The system of claim 16, further comprising, after assigning the changed setting of the user customizable attribute of the model window to the user customizable attribute of the second window, setting a predetermined time for maintaining the assignment.

18. The system of claim 17, further comprising, reverting the user customizable attribute of the second window to the default setting when the predetermined time expires.

19. The system of claim 16, further comprising, before assigning the changed setting of the user customizable attribute of the model window to the user customizable attribute of the second window, storing a current setting of the user customizable attribute of the second window.

20. The system of claim 19, further comprising, after assigning the changed setting of the user customizable attribute of the model window to the user customizable attribute of the second window:
setting a predetermined time for maintaining the assignment; and
reverting the user customizable attribute of the second window to the stored current setting when the predetermined time expires.
